(19) United States
(12) Patent Application Publication
(10) Pub. No.: US 2022/0360121 A1
(43) Pub. Date: Nov. 10, 2022

(54) WIRELESS POWER TRANSMITTING APPARATUS AND WIRELESS CHARGING SYSTEM

(71) Applicant: NINGBO WEIE ELECTRONICS TECHNOLOGY LTD., Ningbo (CN)

(72) Inventors: Cong Yin, Ningbo (CN); Tao Ma, Ningbo (CN); Feng Yu, Ningbo (CN); Weiyi Feng, Ningbo (CN)

(73) Assignee: NINGBO WEIE ELECTRONICS TECHNOLOGY LTD., Ningbo (CN)

(21) Appl. No.: 17/727,248

(22) Filed: Apr. 22, 2022

(30) Foreign Application Priority Data
May 10, 2021 (CN) 202120992568.1

(51) Int. Cl. H02J 50/90; H02J 50/10

(52) U.S. Cl. CPC H02J 50/90; H02J 50/10

(57) ABSTRACT

Disclosed in embodiments of the present disclosure are a wireless power transmitting apparatus and a wireless charging system. The wireless power transmitting apparatus comprises a wireless power transmitting coil, first magnet units and a second magnet unit. The first magnet units arranged at intervals around the wireless power transmitting coil, and the second magnet unit arranged in the center of the wireless power transmitting coil. The wireless charging system comprises the wireless power transmitting apparatus and a wireless power receiving apparatus, which comprises a wireless power receiving coil and magnet units arranged around or at the center of the wireless power receiving coil. Therefore, the technical scheme of the embodiments of the present disclosure can magnetically attract a variety of wireless power equipment for wireless charging, and can provide good adaptability and strong usability.

### CLAIM OF PRIORITY AND CROSS-REFERENCE TO RELATED APPLICATION(S)

This application claims the benefit of Chinese Patent Application No. 202120992568.1, filed on May 10, 2021, entitled “wireless power transmitting apparatus and wireless charging system”, which is incorporated herein by reference in its entirety.

### BACKGROUND OF THE DISCLOSURE

### 1. Field of the Disclosure

The present disclosure relates to the field of wireless charging devices, and more particularly to a wireless power transmitting apparatus and a wireless charging system.

### 2. Description of the Related Art

With the sustainable development of portable mobile communication devices, the wireless charging function is applied more and more widely. However, due to the wireless power receiving coils of the mobile phones and watches with wireless charging function have different shapes, and the internal magnetic structures thereof are different also, in the prior art, it's not available to provide the same wireless power transmitting apparatus for charging, or need to integrate two charging coils inside the same wireless power transmitting apparatus, to magnetically attract the watches and phones respectively so as to charge. Therefore, the existing wireless power transmitting apparatus has many problems, such as complex structure, high cost and inconvenient to carry.

### BRIEF DESCRIPTION OF THE DISCLOSURE

In view of the existing status, embodiments of the present disclosure provide a wireless power transmitting apparatus and a wireless charging system, which can charge the mobile phones and watches wirelessly by using the same wireless power transmitting coils.

In a first aspect, embodiments of the present disclosure provide a wireless power transmitting apparatus, comprising:

a wireless power transmitting coil;

first magnet units, arranged around the wireless power transmitting coil; and

a second magnet unit, arranged at the center of the wireless power transmitting coil.

In some embodiments, the wireless power transmission apparatus is provided with a transmitting surface, one surface of the second magnet unit in proximity to the transmitting surface is a first magnetic pole of the second magnet unit, the other surface of the second magnet unit distal from the transmitting surface is a second magnetic pole of the second magnet unit;

the first magnetic pole of the second magnet unit and the second magnetic pole of the second magnet unit have opposite polarities.

In some embodiments, the wireless power transmission is provided with at least one the second magnet unit.

In some embodiments, the wireless power transmission is provided with a transmitting surface, one surface of the first magnet unit in proximity to the transmitting surface is a first magnetic pole of the first magnet unit, the other surface of the first magnet unit distal from the transmitting surface is a second magnetic pole of the first magnet unit;

the first magnetic pole of the first magnet unit and the second magnetic pole of the first magnet unit have opposite polarities.

In some embodiments, the wireless power transmission is provided with a transmitting surface, on the surface of the first magnet unit in proximity to the transmitting surface, one end close to the wireless power transmitting coil is a first magnetic pole of the first magnet unit, the other end away from the wireless power transmitting coil is a second magnetic pole of the first magnet unit;

on the surface of the first magnet unit distal from the transmitting surface, one end close to the wireless power transmitting coil is the second magnetic pole of the first magnet unit, the other end away from the wireless power transmitting coil is the first magnetic pole of the first magnet unit;

the first magnetic pole of the first magnet unit and the second magnetic pole of the first magnet unit have opposite polarities.

In some embodiments, the wireless power transmission is provided with a transmitting surface, on the surface of the first magnet unit in proximity to the transmitting surface, one end close to and the other end away from the wireless power transmitting coil are first magnetic poles of the first magnet unit, a second magnetic pole of the first magnet unit is disposed between the two first magnetic poles of the first magnet unit;

on the surface of the first magnet unit distal from the transmitting surface, one end close to and the other end away from the wireless power transmitting coil are the second magnetic poles of the first magnet unit, the first magnetic pole of the first magnet unit is disposed between the two second magnetic poles of the first magnet unit;

the first magnetic pole of the first magnet unit and the second magnetic pole of the first magnet unit have opposite polarities.

In some embodiments, wherein the first magnet units are arranged in a circular or a fan-shaped arc around the wireless power transmitting coil.

In some embodiments, the wireless power transmitting apparatus further comprising:

a housing, the wireless power transmitting coil, the first magnet unit and the second magnet unit are arranged in the housing.

In a second aspect, embodiments of the present disclosure provide the wireless charging system comprising:

a wireless power transmitting apparatus as described above; and

a wireless power receiving apparatus;

wherein, the wireless power receiving apparatus comprises a wireless power receiving coil and magnet units arranged around or at the center of the wireless power receiving coil.

Disclosed in embodiments of the present disclosure are a wireless power transmitting apparatus and a wireless charging system. The wireless power transmitting apparatus comprises a wireless power transmitting coil, first magnet units and a second magnet unit. The first magnet units arranged at intervals around the wireless power transmitting coil, and the second magnet unit arranged in the center of the wireless power transmitting coil. The wireless charging system comprises the wireless power transmitting apparatus and a wireless power receiving apparatus, which comprises a wireless power receiving coil and magnet units arranged around or at the center of the wireless power receiving coil. Therefore, the technical scheme of the embodiments of the present disclosure can magnetically attract a variety of wireless power equipment for wireless charging, and can provide good adaptability and strong usability.

### BRIEF DESCRIPTION OF THE DRAWINGS

Through the following description of the embodiments of the present disclosure with reference to the drawings, the above and other objectives, features and advantages of the present disclosure will become more apparent, wherein:

FIG. 1 is a structural schematic diagram of the first embodiment of the wireless power transmitting apparatus according to the embodiments of the present disclosure;

FIG. 2 is a top view of the first embodiment of the wireless power transmitting apparatus according to the embodiments of the present disclosure;

FIG. 3 is a structural schematic diagram of the second embodiment of the wireless power transmitting apparatus according to the embodiments of the present disclosure;

FIG. 4 is a structural schematic diagram of the third embodiment of the wireless power transmitting apparatus according to the embodiments of the present disclosure;

FIG. 5 is a schematic diagram of the fourth embodiment of the wireless power transmitting apparatus according to the embodiments of the present disclosure;

FIG. 6 is a structural diagram of the fifth embodiment of the wireless power transmitting apparatus according to the embodiments of the present disclosure;

FIG. 7 is a schematic diagram of the sixth embodiment of the wireless power transmitting apparatus according to the embodiments of the present disclosure;

FIG. 8 is a working diagram of the third embodiment of the wireless power transmitting apparatus of the wireless charging system adapting to the first wireless power receiving apparatus according to the embodiments of the present disclosure;

FIG. 9 is a working diagram of the fifth embodiment of the wireless power transmitting apparatus of the wireless charging system adapting to the first wireless power receiving apparatus according to the embodiments of the present disclosure;

FIG. 10 is a working diagram of the sixth embodiment of the wireless power transmitting apparatus of the wireless charging system adapting to the first wireless power receiving apparatus according to the embodiments of the present disclosure;

FIG. 11 is a working diagram of the third embodiment of the wireless power transmitting apparatus of the wireless charging system adapting to the second wireless power receiving apparatus according to the embodiments of the present disclosure;

### DESCRIPTION OF REFERENCE SIGNS

A0, the transmitting surface of the wireless power transmitting apparatus; A1, the first embodiment of the wireless power transmitting apparatus; A2, the second embodiment of the wireless power transmitting apparatus; A3, the third embodiment of the wireless power transmitting apparatus; A4, the fourth embodiment of the wireless power transmitting apparatus; A5, the fifth embodiment of the wireless power transmitting apparatus; A6, the sixth embodiment of the wireless power transmitting apparatus; B0, the receiving surface of the wireless power receiving apparatus; B1, the first wireless power receiving apparatus; B2, the second wireless power receiving apparatus.

1, wireless power transmitting coil; 2, first magnet unit; 21, first magnetic pole of first magnet unit; 22, second magnetic pole of first magnet unit; 3, second magnet unit; 31, first magnetic pole of second magnet unit; 32, second magnetic pole of second magnet unit; 4, wireless power receiving coil; 5, magnet unit; 51, first magnetic pole of magnet unit; 52, second magnetic pole of magnet unit; 6, housing.

### DETAILED DESCRIPTION OF EMBODIMENTS OF THE DISCLOSURE

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, a person skilled in the art should understand that the drawings herein are provided for the purpose of description only, and are not necessarily drawn in proportion.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

Unless otherwise stated or defined, the terms “install”, “connected”, “connect”, “fix” and the like should be understood in a broad sense, for example, the term “connected” may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

The technical solution of the present disclosure will be further described below with reference to the accompanying drawings and specific embodiments.

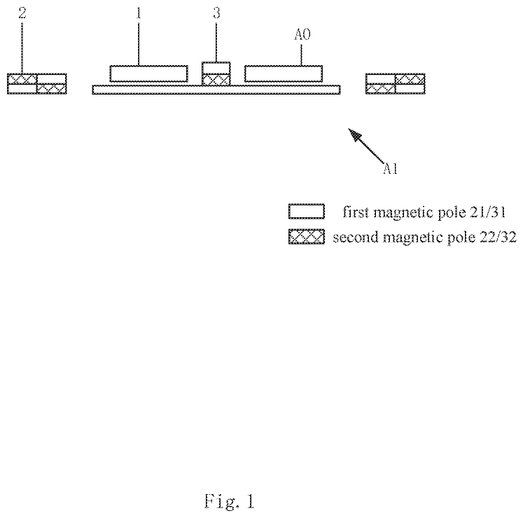

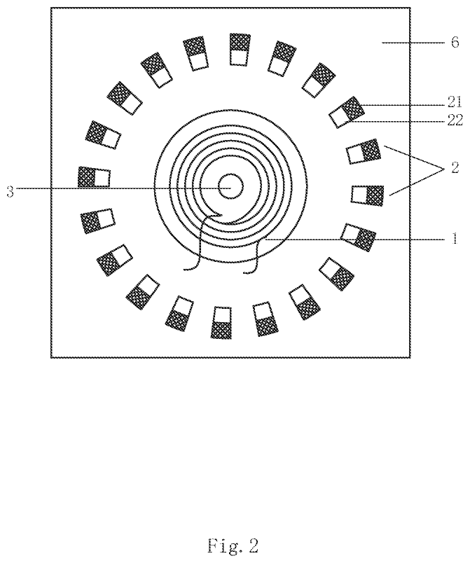

FIG. 1 is a structural schematic diagram of the first embodiment of the wireless power transmitting apparatus according to the embodiments of the present disclosure. FIG. 2 is a top view of the first embodiment of the wireless power transmitting apparatus according to the embodiments of the present disclosure. As shown in FIG. 1 and FIG. 2, the wireless power transmitting apparatus comprises a wireless power transmitting coil 1, first magnet units 2 and a second magnet unit 3. The first magnet units 2 are arranged around the wireless power transmitting coil 1. The second magnet unit 3 is arranged at the center of the wireless power transmitting coil 1. The first magnet unit 2 and the second magnet unit 3 are configured to produce a magnetic attracting effect on the wireless power receiving apparatuses during the wireless charging process, so as to assist in positioning.

In this embodiment, namely the wireless power transmitting apparatus A1, on the surface of the first magnet unit 2 in proximity to the transmitting surface A0, one end close to the wireless power transmitting coil 1 is first magnetic pole of the first magnet unit 21, the other end away from the wireless power transmitting coil 1 is second magnetic pole of the first magnet unit 22. The surface of the second magnet unit 3 in proximity to the transmitting surface A0 is first magnetic pole of the second magnet unit 31. Wherein, the polarity of the first magnetic pole is opposite to the second magnetic pole. In other words, the first magnet unit 2 has two magnetic poles of opposite polarity arranged in a horizontal direction from the center of the wireless power transmitting coil 1 to the external of the device. The second magnet unit 3 has two magnetic poles with opposite polarity arranged in a vertical direction.

Moreover, the wireless power transmitting apparatus has a transmitting surface A0, that is, the surface that can charge the wireless power receiving apparatus wirelessly when using. Due to the characteristics of the magnet, in order to stabilize the magnetism of the magnet unit, the polarity of the magnet unit in proximity to the transmitting surface A0 and the other polarity distal therefrom should be opposite. That is to say, the first magnet unit 2 and the second magnet unit 3 are divided into two layers, the surface in proximity to the transmitting surface A0 is one layer, and the surface distal from the transmitting surface A0 is another layer. In the surface distal from the transmitting surface A0, the end of the first magnet unit 2 close to the wireless power transmitting coil 1 is the second magnetic pole of the first magnet unit 22, and the other end away from the wireless power transmitting coil 1 is the first magnetic pole of the first magnet unit 21. The surface of the second magnet unit 3 distal from the transmitting surface A0 is the second magnetic pole of the second magnet unit 32.

In this embodiment, the first magnetic pole is N pole and the second magnetic pole is S pole. Optionally, the first magnetic pole can also be S pole, in which case the second magnetic pole is N pole. This design varies with specific production needs.

Further, in this embodiment, the first magnet units 2 are arranged in a circular shape and keep a preset distance to the wireless power transmitting coil 1. Optionally, the first magnet unit 2 can be arranged in a shape other than circle, such as a fan, that is, the first magnet unit 2 can be arranged only in part of the circular arc, so as to achieve an effect, that magnetically attracting with the wireless power receiving apparatus for positioning. The number and shape of the first magnet units 2, as well as the distance to the wireless power transmitting coil 1 there between, are not limited in this disclosure, which can be varied according to the specific production needs.

Further, in this embodiment, there is one second magnet unit 3. Optionally, the wireless power transmitting apparatus may have more than one second magnet unit 3, and this disclosure does not limit the number or shape of the second magnet unit 3 also. In addition, in order to stabilize the performance of the wireless power transmitting apparatus, according to the characteristics of magnets, when there are multiple second magnet units 3 exist, on the surface in proximity to the transmitting surface A0, the polarity of each second magnet unit 3 shall be the same, so as to ensure the magnetic absorption efficiency. For example, all the polarities are the first magnetic pole of the second magnet unit 31.

Further, the wireless power transmitting apparatus comprises a housing 6, a wireless power transmitting coil 1, first magnet units 2 and a second magnet unit 3 arranged in the housing 6. Optionally, the shape and size of housing 6 vary with the internal structure and specific production needs of the wireless power transmitting apparatus.

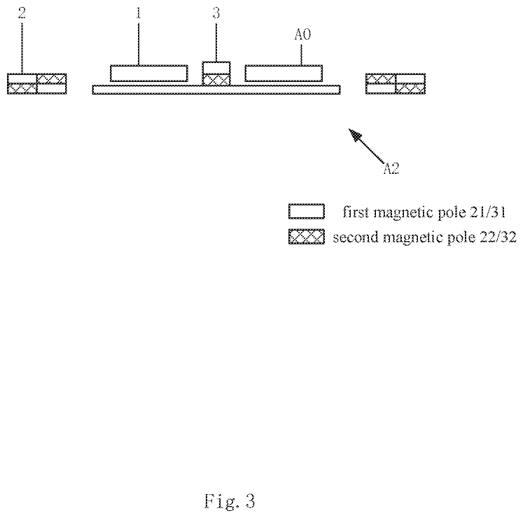

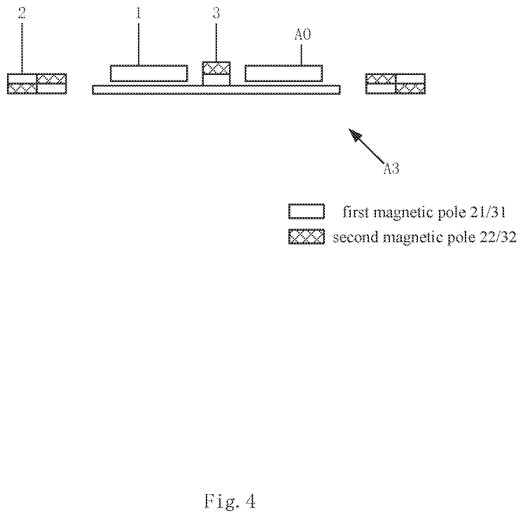

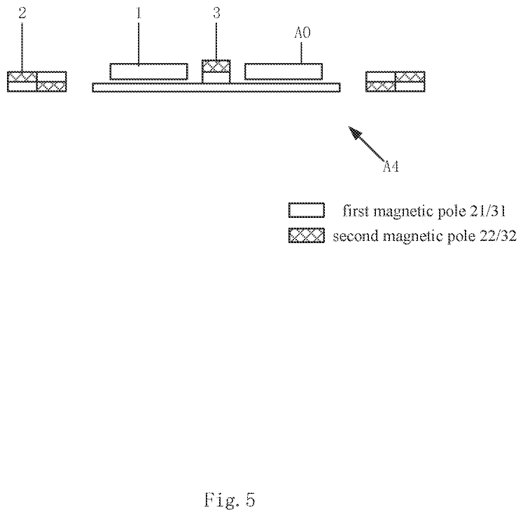

FIG. 3 is a structural schematic diagram of the second embodiment of the wireless power transmitting apparatus according to the embodiments of the present disclosure. FIG. 4 is a structural schematic diagram of the third embodiment of the wireless power transmitting apparatus according to the embodiments of the present disclosure. FIG. 5 is a schematic diagram of the fourth embodiment of the wireless power transmitting apparatus according to the embodiments of the present disclosure. As shown in FIG. 3, FIG. 4 and FIG. 5, in the second embodiment of the present disclosure, namely the wireless power transmitting apparatus A2, on the surface of the first magnet unit 2 in proximity to the transmitting surface A0, one end close to the wireless power transmitting coil 1 is second magnetic pole of the first magnet unit 22, the other end away from the wireless power transmitting coil 1 is first magnetic pole of the first magnet unit 21. The surface of the second magnet unit 3 in proximity to the transmitting surface A0 is first magnetic pole of the second magnet unit 31.

In the third embodiment of the present disclosure, namely the wireless power transmitting apparatus A3, on the surface of the first magnet unit 2 in proximity to the transmitting surface A0, one end close to the wireless power transmitting coil 1 is second magnetic pole of the first magnet unit 22, the other end away from the wireless power transmitting coil 1 is first magnetic pole of the first magnet unit 21. The surface of the second magnet unit 3 in proximity to the transmitting surface A0 is second magnetic pole of the second magnet unit 32.

In the fourth embodiment of the present disclosure, namely the wireless power transmitting apparatus A4, on the surface of the first magnet unit 2 in proximity to the transmitting surface A0, one end close to the wireless power transmitting coil 1 is first magnetic pole of the first magnet unit 21, the other end away from the wireless power transmitting coil 1 is second magnetic pole of the first magnet unit 22. The surface of the second magnet unit 3 in proximity to the transmitting surface A0 is second magnetic pole of the second magnet unit 32.

In other words, the arrangement of the magnetic poles of the first magnet unit 2 and the second magnet unit 3 can be varied according to the specific production needs, and there is no limitation in this disclosure.

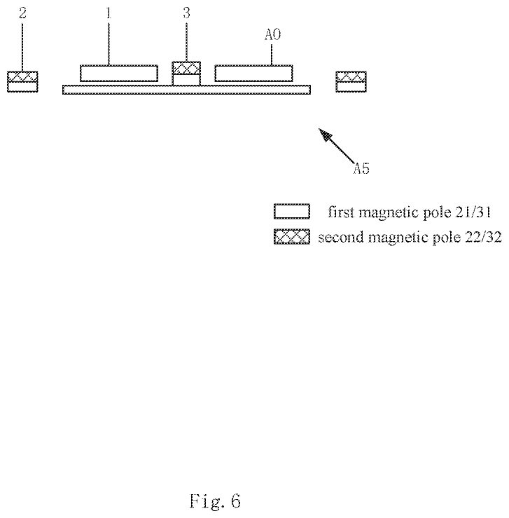

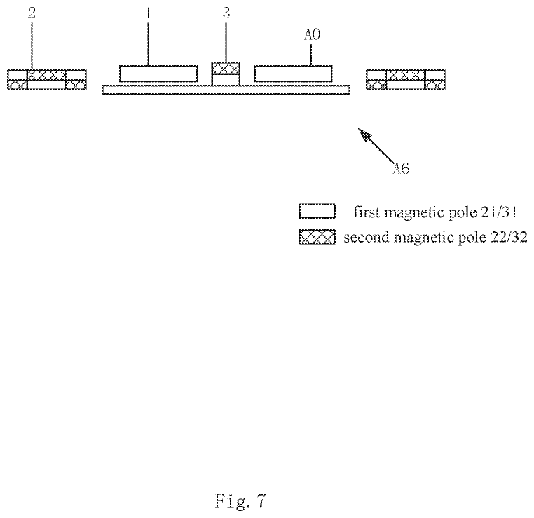

FIG. 6 is a structural diagram of the fifth embodiment of the wireless power transmitting apparatus according to the embodiments of the present disclosure. FIG. 7 is a schematic diagram of the sixth embodiment of the wireless power transmitting apparatus according to the embodiments of the present disclosure. As shown in FIG. 6 and FIG. 7, the number of poles in the first magnet unit 2 can be varied.

In the fifth embodiment of the present disclosure, namely the wireless power transmitting apparatus A5, one surface of the first magnet unit 2 in proximity to the transmitting surface A0 is second magnetic pole of the first magnet unit 22, the other surface distal from the transmitting surface A0 is first magnetic pole of the first magnet unit 21. In other words, in this embodiment, the surface of the first magnet unit 2 in proximity to the transmitting surface A0 has only one magnetic pole. Optionally, the polarity setting can be varied according to the specific production needs. For example, one surface of the first magnet unit 2 in proximity to the transmitting surface A0 can be first magnetic pole of the first magnet unit 21, in which case the other surface distal from the transmitting surface A0 can be second magnetic pole of the first magnet unit (22).

In the sixth embodiment of the present disclosure, namely the wireless power transmitting apparatus A6, on the surface of the first magnet unit 2 in proximity to the transmitting surface A0, one end close to and the other end away from the wireless power transmitting coil 1 are first magnetic poles of the first magnet unit 21, and second magnetic pole of the first magnet unit 22 is disposed there between. According to the characteristic of the magnet, on the surface of the magnet unit 2 distal from the transmitting surface A0, the setting of the magnetic poles should be contrary to the foregoing, that is, one end close to and the other end away from the wireless power transmitting coil 1 are second magnetic poles of the first magnet unit 22, and first magnetic pole of the first magnet unit 21 is disposed there between. In other words, in this embodiment, the first magnet unit 2 has three magnetic poles arranged in a direction from the center of the wireless power transmitting coil 1 to the external of the device, with the polarities at both ends consistent, and the polarity in the middle opposite. Optionally, the polarities of the three magnetic poles can be changed according to specific production needs.

Optionally, the first magnet unit 2 may also have other numbers of magnetic poles or other magnetic pole arrangements, which are not limited herein. In the above two embodiments, the surface of the second magnet unit 3 in proximity to the transmitting surface A0 is second magnetic pole of the second magnet unit 32, and other surface distal from the transmitting surface A0 is first magnetic pole of the second magnet unit 31. Optionally, this setting can be varied depending on specific production needs.

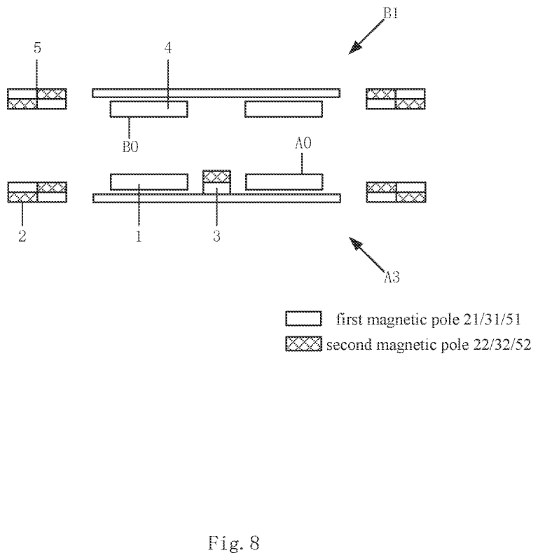

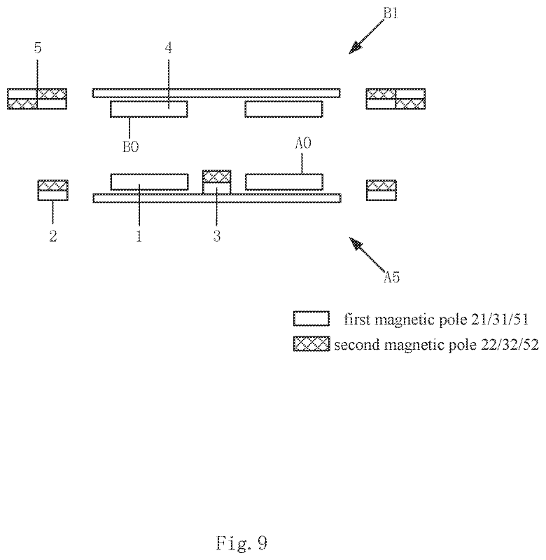

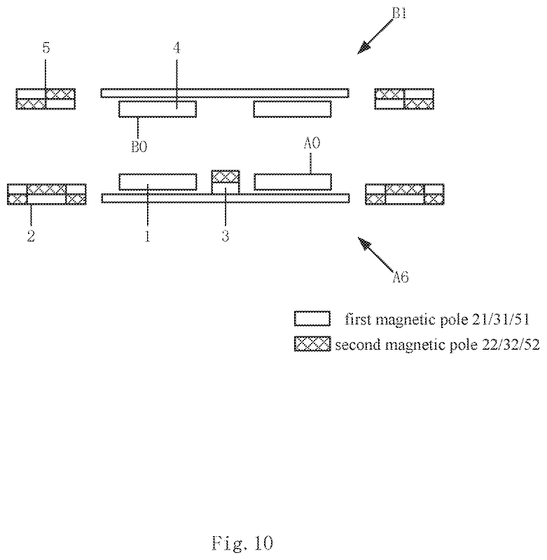

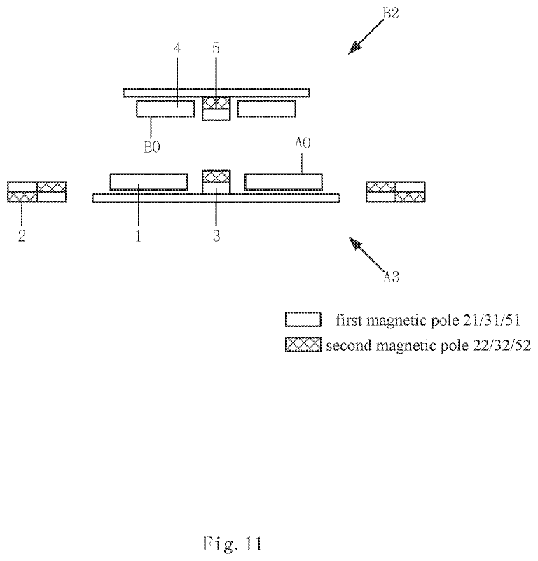

FIG. 8, FIG. 9 and FIG. 10 are working diagrams of the third, the fifth and the sixth embodiment of the wireless power transmitting apparatus of the wireless charging system respectively adapting to the first wireless power receiving apparatus according to the embodiments of the present disclosure. FIG. 11 is a working diagram of the third embodiment of the wireless power transmitting apparatus of the wireless charging system adapting to the second wireless power receiving apparatus according to the embodiments of the present disclosure. As shown in FIG. 8, FIG. 9, FIG. 10 and FIG. 11, the wireless charging system includes the wireless power transmitting apparatus and wireless power receiving apparatus. Wherein, the wireless power receiving apparatus comprises a wireless power receiving coil 4 and magnet units 5 arranged around or at the center of the wireless power receiving coil 4.

In the prior art, wireless power is received and transmitted by electromagnetic induction principle, by disposing two coils close to each other, when the current flows in one of the coils, the generated magnetic flux becomes medium, so as to bring electromotive force in the other coil. Therefore, the existing wireless power receiving apparatus and radio energy emitting device can be equipped with magnet units to produce magnetic positioning effect. In order to illustrate that the wireless power transmitting apparatus of the present disclosure can be coupled with a variety of products, such as mobile phones and watches with wireless charging function, the first wireless power receiving apparatus B1 will be seen as the wireless charging structure of mobile phones, and the second wireless power receiving apparatus B2 will be seen as the wireless charging structure of watches. Wherein, the wireless power receiving apparatus B1 and B2 have a receiving surface B0, that is, the surface that can receive wireless power when using.

In the first wireless power receiving apparatus B1, disposed the magnet units 5 around the wireless power receiving coil 4, on the surface of the magnet unit 5 in proximity to the receiving surface B0, one end close to the wireless power receiving coil 4 is first magnetic pole of the magnet unit 51, the other end away from the wireless power receiving coil 4 is second magnetic pole of the first magnet unit 52. In the working process of the wireless power transmitting apparatus A3 adapting to the first wireless power receiving apparatus B1, the second magnetic pole 22 of the first magnet unit 2 and the first magnetic pole 51 of the magnet unit 5 towards each other, in the meantime, the first magnetic pole 21 of the first magnet unit 2 and the second magnetic pole 52 of the magnet unit 5 towards each other. Due to the polarities of the first magnetic poles 21/51 and the second magnetic poles 22/52 are opposite, so as to attract each other, the wireless power transmitting apparatus A3 can provide an auxiliary positioning effect while charging the first wireless power receiving apparatus B1 wirelessly. Similarly, in the working process of the wireless power transmitting apparatus A5 adapting to the first wireless power receiving apparatus B1, the second magnetic pole 22 of the first magnet unit 2 and the first magnetic pole 51 of the magnet unit 5 towards each other and produce an attracting effect. In the working process of the wireless power transmitting apparatus A6 adapting to the first wireless power receiving apparatus B1, the first magnetic pole 21 of the first magnet unit 2 and the second magnetic pole 52 of the magnet unit 5 towards each other, in the meantime, the second magnetic pole 22 of the first magnet unit 2 and the first magnetic pole 51 of the magnet unit 5 towards each other, due to the polarities of the first magnetic poles 21/51 and the second magnetic poles 22/52 are opposite, so as to provide an attracting effect.

In the second wireless power receiving apparatus B2, the magnet unit 5 is disposed in the center of wireless power receiving coil 4, and the surface of the magnet unit 5 in proximity to receiving surface B0 is the first magnetic pole 51. In the working process of the wireless power transmitting apparatus A3 adapting to the second wireless power receiving apparatus B2, the second magnetic pole 32 of the second magnet unit 3 and the first magnetic pole 51 of the magnet unit 5 towards each other, due to the polarities of the first magnetic poles 51 and the second magnetic poles 32 are opposite, so as to provide an attracting effect.

According to the above description, when adapting the first wireless power receiving apparatus B1 similar to the wireless charging structure of a mobile phone, coordinating with the magnet unit 5, the first magnet unit 2 of the wireless power transmitting apparatus of the present disclosure can provide an attracting effect, so as to assist in positioning. When adapting the second wireless power receiving apparatus B2 similar to the wireless charging structure of a watch, the second magnet unit 3 and magnet unit 5 are attracted to each other, so as to play in a part of positioning. Therefore, the wireless power transmitting apparatus of the present disclosure can adapt to a variety of products, the same wireless power transmitting apparatus coil 1 can be used to charge the mobile phone and the watch wirelessly, at the same time provide magnetic attracting effect of auxiliary positioning. Optionally, in the wireless power receiving apparatus B1 and B2, the magnet unit 5 may also have other magnetic pole arrangements.

Disclosed in embodiments of the present disclosure are a wireless power transmitting apparatus and a wireless charging system. The wireless power transmitting apparatus comprises a wireless power transmitting coil, first magnet units and a second magnet unit. The first magnet units arranged at intervals around the wireless power transmitting coil, and the second magnet unit arranged in the center of the wireless power transmitting coil. The wireless charging system comprises the wireless power transmitting apparatus and a wireless power receiving apparatus, which comprises a wireless power receiving coil and magnet units arranged around or at the center of the wireless power receiving coil. Therefore, the technical scheme of the embodiments of the present disclosure can magnetically attract a variety of wireless power equipment for wireless charging, and can provide good adaptability and strong usability.

The descriptions above are only preferred embodiments of the present disclosure, but are not intended to limit the present disclosure. For a person skilled in the art, the present disclosure may have various changes and variations. Any modifications, equivalent substitutions, improvements and the like made within the spirit and principles of the present disclosure are all intended to be concluded in the protection scope of the present disclosure.

I/We claim:

1. A wireless power transmitting apparatus, comprising:
a wireless power transmitting coil (1);
first magnet units (2), arranged around the wireless power transmitting coil (1); and
a second magnet unit (3), arranged at the center of the wireless power transmitting coil (1).

2. The wireless power transmitting apparatus according to claim 1, wherein the wireless power transmission apparatus is provided with a transmitting surface, one surface of the second magnet unit (3) in proximity to the transmitting surface is a first magnetic pole of the second magnet unit (31), the other surface of the second magnet unit (3) distal from the transmitting surface is a second magnetic pole of the second magnet unit (32);
the first magnetic pole of the second magnet unit (31) and the second magnetic pole of the second magnet unit (32) have opposite polarities.

3. The wireless power transmitting apparatus according to claim 1, wherein the wireless power transmission is provided with at least one the second magnet unit (3).

4. The wireless power transmitting apparatus according to claim 2, one surface of the first magnet unit (2) in proximity to the transmitting surface is a first magnetic pole of the first magnet unit (21), the other surface of the first magnet unit (2) distal from the transmitting surface is a second magnetic pole of the first magnet unit (22);
the first magnetic pole of the first magnet unit (21) and the second magnetic pole of the first magnet unit (22) have opposite polarities.

5. The wireless power transmitting apparatus according to claim 2, on the surface of the first magnet unit (2) in proximity to the transmitting surface, one end close to the wireless power transmitting coil (1) is a first magnetic pole of the first magnet unit (21), the other end away from the wireless power transmitting coil (1) is a second magnetic pole of the first magnet unit (22);
on the surface of the first magnet unit (2) distal from the transmitting surface, one end close to the wireless power transmitting coil (1) is the second magnetic pole of the first magnet unit (22), the other end away from the wireless power transmitting coil (1) is the first magnetic pole of the first magnet unit (21);
the first magnetic pole of the first magnet unit (21) and the second magnetic pole of the first magnet unit (22) have opposite polarities.

6. The wireless power transmitting apparatus according to claim 2, on the surface of the first magnet unit (2) in proximity to the transmitting surface, one end close to and the other end away from the wireless power transmitting coil (1) are first magnetic poles of the first magnet unit (21), a second magnetic pole of the first magnet unit (22) is disposed between the two first magnetic poles of the first magnet unit (21);
on the surface of the first magnet unit (2) distal from the transmitting surface, one end close to and the other end away from the wireless power transmitting coil (1) are the second magnetic poles of the first magnet unit (22), the first magnetic pole of the first magnet unit (21) is disposed between the two second magnetic poles of the first magnet unit (22);
the first magnetic pole of the first magnet unit (21) and the second magnetic pole of the first magnet unit (22) have opposite polarities.

7. The wireless power transmitting apparatus according to claim 1, wherein the first magnet units (2) are arranged in a circular or a fan-shaped arc around the wireless power transmitting coil (1).

8. The wireless power transmitting apparatus according to claim 1, wherein the wireless power transmitting apparatus further comprising:
a housing (6), the wireless power transmitting coil (1), the first magnet unit (2) and the second magnet unit (3) are arranged in the housing (6).

9. The wireless power transmitting apparatus according to claim 1, wherein the wireless power transmitting apparatus further comprising:
a magnetic sheet, arranged at one side of the wireless power transmitting coil (1);
wherein, the wireless power transmission apparatus is provided with a transmitting surface, the transmitting surface is positioned on surface of the wireless power transmitting coil (1) distal from the magnetic sheet.

10. The wireless power transmitting apparatus according to claim 9, wherein the first magnet unit (2) and the second magnet unit (3) are divided into two layers, surface of the first magnet unit (2) and the second magnet unit (3) in proximity to the transmitting surface is a first layer, and surface of the first magnet unit (2) and the second magnet unit (3) distal from the transmitting surface is a second layer;
wherein the magnetic poles of the first layer and the second layer have opposite polarities.

11. A wireless charging system, comprising:
a wireless power transmitting apparatus, comprising a wireless power transmitting coil (1), first magnet units (2) and a second magnet unit (3), wherein the first magnet units (2) arranged around the wireless power transmitting coil (1), and the second magnet unit (3) arranged at the center of the wireless power transmitting coil (1); and
a wireless power receiving apparatus, comprising a wireless power receiving coil (4) and magnet units (5) arranged around or at the center of the wireless power receiving coil (4).

12. The wireless charging system according to claim 11, wherein the wireless power transmission apparatus is provided with a transmitting surface, one surface of the second magnet unit (3) in proximity to the transmitting surface is a first magnetic pole of the second magnet unit (31), the other surface of the second magnet unit (3) distal from the transmitting surface is a second magnetic pole of the second magnet unit (32);
the first magnetic pole of the second magnet unit (31) and the second magnetic pole of the second magnet unit (32) have opposite polarities.

13. The wireless charging system according to claim 11, wherein the wireless power transmission is provided with at least one the second magnet unit (3).

14. The wireless charging system according to claim 12, one surface of the first magnet unit (2) in proximity to the transmitting surface is a first magnetic pole of the first magnet unit (21), the other surface of the first magnet unit (2) distal from the transmitting surface is a second magnetic pole of the first magnet unit (22);
the first magnetic pole of the first magnet unit (21) and the second magnetic pole of the first magnet unit (22) have opposite polarities.

15. The wireless charging system according to claim 12, on the surface of the first magnet unit (2) in proximity to the transmitting surface, one end close to the wireless power transmitting coil (1) is a first magnetic pole of the first magnet unit (21), the other end away from the wireless power transmitting coil (1) is a second magnetic pole of the first magnet unit (22);
on the surface of the first magnet unit (2) distal from the transmitting surface, one end close to the wireless power transmitting coil (1) is the second magnetic pole of the first magnet unit (22), the other end away from the wireless power transmitting coil (1) is the first magnetic pole of the first magnet unit (21);
the first magnetic pole of the first magnet unit (21) and the second magnetic pole of the first magnet unit (22) have opposite polarities.

16. The wireless charging system according to claim 12, on the surface of the first magnet unit (2) in proximity to the transmitting surface, one end close to and the other end away from the wireless power transmitting coil (1) are first magnetic poles of the first magnet unit (21), a second magnetic pole of the first magnet unit (22) is disposed between the two first magnetic poles of the first magnet unit (21);
on the surface of the first magnet unit (2) distal from the transmitting surface, one end close to and the other end away from the wireless power transmitting coil (1) are the second magnetic poles of the first magnet unit (22), the first magnetic pole of the first magnet unit (21) is disposed between the two second magnetic poles of the first magnet unit (22);
the first magnetic pole of the first magnet unit (21) and the second magnetic pole of the first magnet unit (22) have opposite polarities.

17. The wireless charging system according to claim 11, wherein the first magnet units (2) are arranged in a circular or a fan-shaped arc around the wireless power transmitting coil (1).

18. The wireless charging system according to claim 11, wherein the wireless power transmitting apparatus further comprising:
a housing (6), the wireless power transmitting coil (1), the first magnet unit (2) and the second magnet unit (3) are arranged in the housing (6).

19. The wireless charging system according to claim 11, wherein the wireless power transmitting apparatus further comprising:
a magnetic sheet, arranged at one side of the wireless power transmitting coil (1);
wherein, the wireless power transmission apparatus is provided with a transmitting surface, the transmitting surface is positioned on surface of the wireless power transmitting coil (1) distal from the magnetic sheet.

20. The wireless charging system according to claim 19, wherein the first magnet unit (2) and the second magnet unit (3) are divided into two layers, surface of the first magnet unit (2) and the second magnet unit (3) in proximity to the transmitting surface is a first layer, and surface of the first magnet unit (2) and the second magnet unit (3) distal from the transmitting surface is a second layer;
wherein the magnetic poles of the first layer and the second layer have opposite polarities.
